(19) United States
(12) Patent Application Publication
(10) Pub. No.: US 2012/0013629 A1
(43) Pub. Date: Jan. 19, 2012

(54) Reading Compressed Anti-Aliased Images

(75) Inventor: Mark FOWLER, Hopkinton, MA (US)

(73) Assignee: Advanced Micro Devices, Inc., Sunnyvale, CA (US)

(21) Appl. No.: 13/186,266

(22) Filed: Jul. 19, 2011

Related U.S. Application Data
(60) Provisional application No. 61/365,702, filed on Jul. 19, 2010.

(51) Int. Cl. G09G 5/39

(52) U.S. Cl. 345/531

(57) ABSTRACT

Embodiments of the present invention enable the reduction of the memory bandwidth required for graphics rendering. According to an embodiment, a method to render a pixel from a compressed anti-aliased image includes: accessing metadata for the pixel, where the metadata includes entries for respective samples generated by multisampling the pixel; and retrieving a subset of said samples based upon the metadata, wherein the subset is stored in the compressed anti-aliased image stored in a memory.

### CROSS REFERENCE TO RELATED APPLICATIONS

This application claims the benefit of U.S. provisional application No. 61/365,702, filed on Jul. 19, 2010, which is hereby incorporated by reference in its entirety.

### BACKGROUND

1. Field

Embodiments of the present invention are related to improving the performance of image rendering.

2. Background Art

Many applications require rendering of increasingly complex graphics at faster speeds. For example, applications such as video games increasingly demand fast response times and more realistic views in image rendering. Fast response times require increased processing speeds and fast access to memory. More realistic graphics views require the rendering of complex imagery. Often, memory access is a significant factor in the processing speed. Accessing large amounts of image surface data in memory, for example, can result in a processing bottleneck due to shortage of memory bandwidth. Various techniques for rendering complex graphics, such as multipass rendering to achieve various lighting effects, result in even more data being transferred to and from memory thereby increasing the demands upon memory bandwidth.

Memory bandwidth refers to the data transfer capacity to/from a memory. For example, the capacity of data transfer between a processor and graphics memory and/or system memory is a factor in the performance when rendering graphics on a graphics processing unit (GPU) or other processor, such as, for example, a general purpose graphics processing unit (GPGPU).

In some graphics processing modes, such as when anti aliasing (AA) is enabled, the memory footprint required for processing a frame is substantially increased. For example, when multisampling or supersampling is used for AA, each pixel of a frame can include multiple samples, thus significantly increasing the size of the frame data that is stored in memory. The increase in the required memory footprint can lead to performance degradations due to scalability limitations, bandwidth limitations, and delays in rendering frames.

What are needed, then, are methods and systems that reduce the demands on memory bandwidth required in graphics processing.

### BRIEF SUMMARY OF EMBODIMENTS OF THE INVENTION

Embodiments of the present invention enable the reduction of memory bandwidth required for graphics rendering. According to an embodiment, a method to render a pixel from a compressed anti-aliased image includes: accessing metadata for the pixel where the metadata includes entries for respective samples generated by multisampling the pixel; and determining a subset of said samples based upon the metadata wherein the subset is stored in the compressed anti-aliased image stored in a memory.

Another embodiment is a system to render a pixel from a compressed anti-aliased image. The system includes a processor; at least one memory configured to store the compressed anti-aliased image; metadata table comprising a metadata for the pixel; and a compressed anti-aliased image reader. The compressed anti-aliased image reader is configured to: access the metadata table wherein the metadata table includes entries for respective samples generated by multisampling the pixel; and retrieve a subset of said samples based upon the metadata wherein the subset is stored in the compressed anti-aliased image.

Yet another embodiment is a computer readable media storing instructions wherein said instructions when executed are adapted to render a pixel from a compressed anti-aliased image using at least one processor with a method including: accessing metadata for the pixel wherein the metadata includes entries for respective samples generated by multisampling the pixel; and retrieving a subset of said samples based upon the metadata wherein the subset is stored in the compressed anti-aliased image stored in a memory.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the pertinent art to make and use embodiments of the invention.

FIG. 1 shows a block diagram of an exemplary graphics computing environment, according to an embodiment of the present invention.

FIG. 2 illustrates a compression scheme for compressing anti-aliased image samples according to an embodiment of the present invention.

FIG. 3 is a flowchart illustrating an exemplary processing of a frame according to an embodiment of the present invention.

The present invention will be described with reference to the accompanying drawings. Generally, the drawing in which an element first appears is typically indicated by the leftmost digit(s) in the corresponding reference number.

### DETAILED DESCRIPTION OF EMBODIMENTS OF THE INVENTION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Anti-aliasing is performed frequently in order to reduce edge effects in the display of images. Anti-aliasing of image frames, such as by supersampling or multisampling, generates a plurality of samples for each pixel of the image. In supersampling, the original image is rendered at a high resolution and several samples from the high resolution image are combined (or averaged) to render the image at the desired resolution. In multisampling, the pixel is sampled at several locations. For example, in 4×AA multisampled image, 4 samples are taken of each pixel. Storing each of these multiple samples can be unnecessarily expensive in terms of memory storage costs.

Furthermore, in the case of most pixels, only a few of the samples are actually used in rendering. Embodiments of the present invention are directed to utilizing the multisampled pixel samples in a manner to efficiently render images based on them. According to an embodiment, the multisampled AA samples are compressed before storage, and the compressed samples are subsequently read back for rendering and/or texture mapping. By reading the compressed samples for texture mapping, the memory bandwidth utilization is substantially reduced. By reducing the memory footprint required to store the multisampled samples, embodiments of the present invention also enables the storing of more render surfaces in GPU memory rather than in system memory.

In the following description, embodiments of the present invention are described primarily in relation to multisampling. Persons skilled in the art, however, would recognize that other methods of AA can also be used.

### System to Read Compressed AA Samples

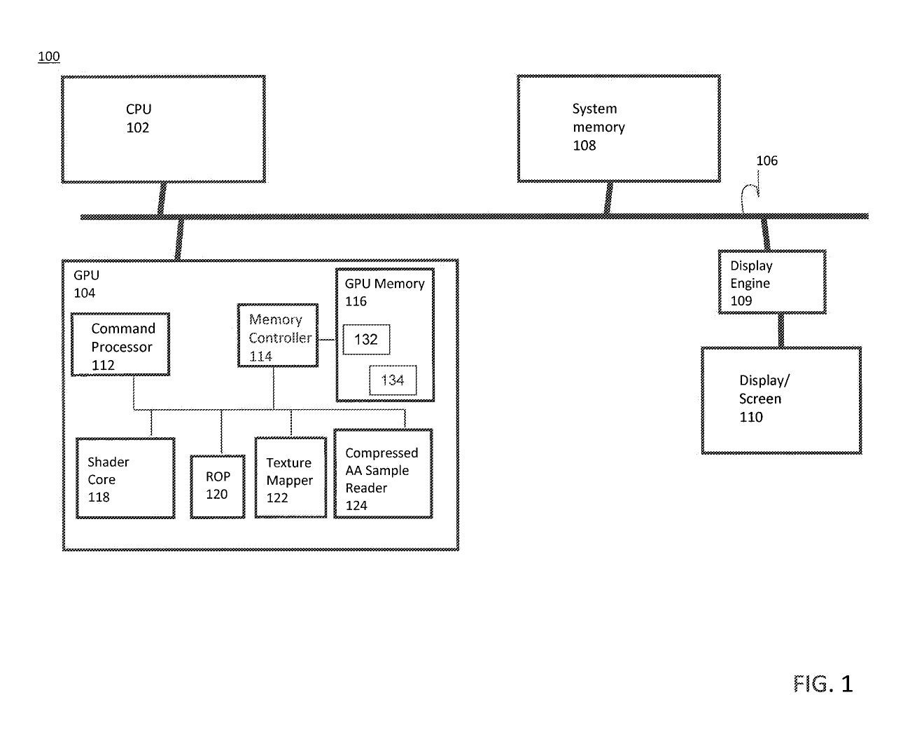

FIG. 1 shows a computing environment according to an embodiment of the present invention. For example, computing environment 100 includes a central processing unit (CPU) 102 coupled to a GPU 104. As would be appreciated by those skilled in the relevant art(s) based on the description herein, embodiments of the present invention can include one or more GPUs shown. GPU 104 may be coupled to additional components such as memories, displays, etc. GPU 104 receives graphics related tasks, such as graphics processing (e.g., rendering) or display tasks, from CPU 102. As will be understood by those of ordinary skill in the art, GPU 104 may be, as illustrated, discrete components (i.e., separate devices), integrated components (e.g., integrated into a single device such as a single integrated circuit (IC), a single package housing multiple ICs, integrated into other ICs—e.g., a CPU or a Northbridge) and may be dissimilar (e.g., having some differing capabilities such as, for example, performance).

GPU 104 can include a command processor 112, a memory controller 114, local graphics memory 116, and a shader core 118. Command processor 112 controls the command execution on GPU 104. For example, command processor 112 can control and/or coordinate the receiving of commands and data from CPU 102 to be processed in GPU 104. Command processor 112 can also control and/or coordinate allocation of memory in graphics memory 116, in general through memory controller 114. Memory controller 114 can control access to graphics memory 116 for the reading and writing of data. In some embodiments, memory controller can also arbitrate between system memory 108 and graphics memory 116, so that the data needed for processing can be obtained from either memory. Shader core 118 includes processing units which execute various processing tasks, such as graphics processing threads. For example, the processing units in shader core 118 can include a plurality of single instruction multiple data (SIMD) processing units. The graphics processing threads that execute on shader core 118 can include shader programs (sometimes also referred to as simply “shader”) such as vertex shaders, geometry shaders, and pixel shaders. Other graphics processing threads such as rendering threads can also execute on shader core 118. Tasks to be executed in shader core 118 can be allocated by, for example, command processor 112.

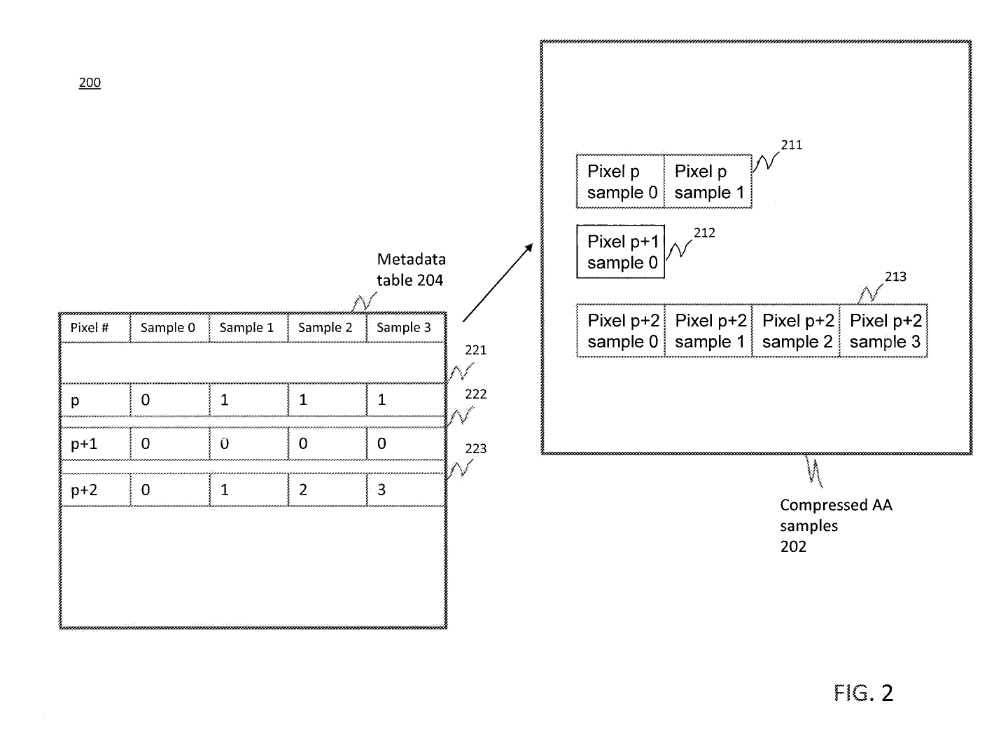

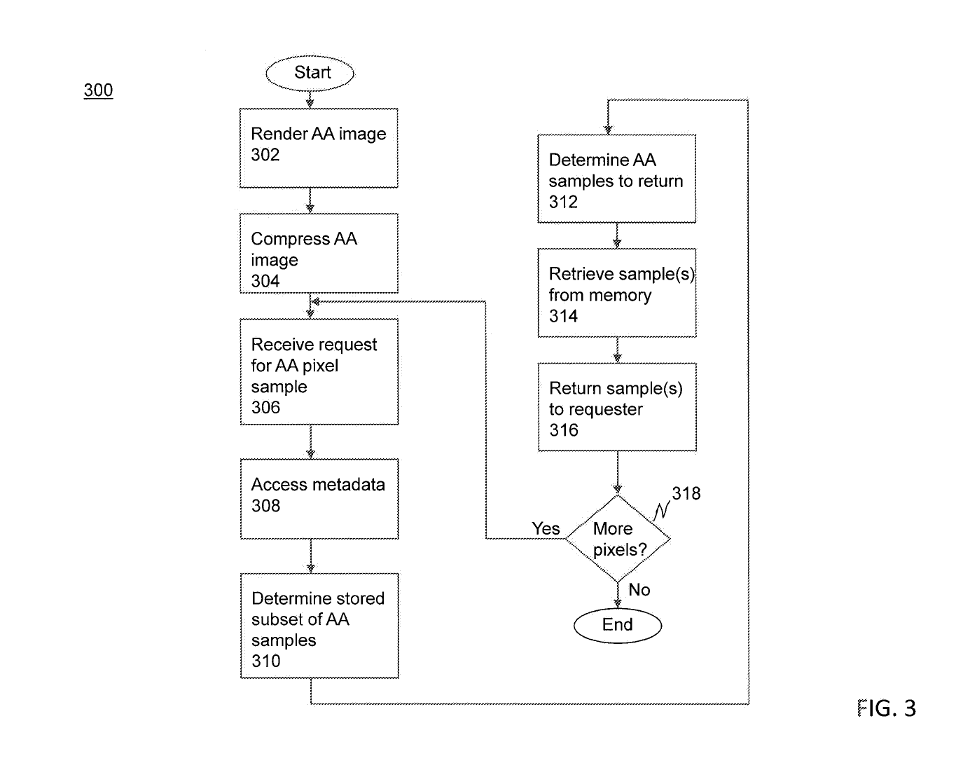

According to an embodiment, GPU 104 can also include other modules, such as, a render operations block (ROP) 120, a texture mapper 122, and a compressed AA reader 124. The logic of ROP 120, texture mapper 122, and compressed AA reader 124 can be implemented using hardware, firmware, software, or a combination thereof. ROP 120 includes logic to render a screen to memory and/or other location. For example, ROP 120 can include logic to render an image to memory from the output of the pixel processing shaders. ROP 120 includes logic to compress anti-aliased frames before storing the samples in memory. The samples can be stored in system memory and/or in graphics memory. Storing of the samples in graphics memory yields faster access to these samples when rendering and/or texture mapping. According to an embodiment, ROP 120 compresses multisampled samples before storing them in graphics memory 116. FIG. 2 illustrates an exemplary compression applied to a set of multisampled samples. The storing of compressed samples is further described with respect to FIGS. 2 and 3 below.

Texture mapper 122 includes logic to perform texture mapping and/or rendering of an image using the multisampled samples stored in memory. For example, texture mapper 122 can read the multisampled sampled from memory in order to texture map a graphics object and to depict various lighting effects. In many applications, rendering and texture mapping an image can involve multiple passes of rendering and texture mapping thereby leading to increased memory traffic. According to an embodiment, texture mapper 122 can invoke compressed AA reader 124 to read the compressed multisampled samples of a pixel without having to decompress the compressed samples.

Compressed AA reader 124 includes logic to read the compressed multisampled samples. According to an embodiment, compressed AA reader 124 is configured to take a request for one or more pixel samples as input specifying a pixel identifier and optionally a sample identifier, and return the values corresponding to that one or more samples. Compressed AA reader 124 can be configured to read the compressed samples without first having to uncompress the samples. Not having to uncompress the samples enable embodiments of the present invention to maintain the memory footprint reduction achieved by compressing the samples of the pixel and to reduce memory bandwidth utilization. Upon receiving a request for a pixel sample, compressed AA reader 124 can access an entry corresponding to the queried pixel in metadata table 132. The entry in metadata table 132 corresponding to the queried pixel, according to an embodiment, can have as many sample indicators (or pointers) as the number of samples generated according to the multisampling scheme. According to the compression scheme for multisampled samples, less than all of the samples may be stored in memory. The value in each sample indicator represents a sample with the same attributes as the sample corresponding to the respective sample indicator. In an embodiment, the lowest indexed sample with the same attributes as the sample corresponding to the respective sample indicator is written as the value of the sample indicator. Based on the value of the sample indicator, compressed AA reader 124 can access memory to obtain the requested sample from a memory, for example, from sample storage 134, or can return the attributes from a sample previously provided to the querying entity. Sample storage 134 can include compressed multisampled samples. For example, for each pixel, only one sample may be stored in sample storage 134 for samples having the same attributes. Reading of compressed AA is further described in relation to FIGS. 2 and 3 below.

Computing environment 100 also includes a system memory 108. System memory 108 can be used for holding the commands and data that are transferred between GPU 104 and CPU 102. In some embodiment, system memory can also include metadata table 132 and/or compressed AA sample storage 134. After the data is processed using graphics operations, the processed data can be written back to system memory by GPU 104. For example, in some embodiments, processed data from graphics memory 116 can be written to system memory 108 prior to be being used for further processing or for display on a screen such as screen 110. In some embodiments, frame data processed in GPU 104 is written to screen 110 through a display engine 109. Display engine 109 can be implemented in hardware and/or software or as a combination thereof, and may include functionality to optimize the display of data based upon the characteristics of screen 110. In another embodiment, display engine 109 can receive processed display data directly from GPU memory 116 and/or system memory 108.

The various devices of computing system 100 are coupled by a communication infrastructure 106. For example, communication infrastructure 106 can include one or more communication buses including a Peripheral Component Interconnect Express (PCI-E). Communications infrastructure 106 can also include, for example, Ethernet, Firewire, or other interconnection devices.

In the description above GPU 104 has been depicted as including selected components and functionalities. A person skilled in the art will, however, understand that one or both GPUs 104 can include other components such as, but not limited to, primitive assemblies, sequencers, shader export memories, registers, and the like.

FIG. 2 illustrates example 200 showing compressed AA sample storage 202 and a corresponding metadata table 204. The samples stored in example 200 can be generated based on 4×AA multisampling, resulting in four samples for each pixel in a surface. Example 200 illustrates the storage of three exemplary pixels p, p+1, and p+2. In compressed AA storage 202 memory area, two samples are stored corresponding to pixel p, one sample corresponding to pixel p+1, and all four samples corresponding to pixel p+2.

Pixel p has only two samples stored because, of the four multisampled samples generated by 4×AA for pixel p, three samples have the same or substantially the same attributes. Only one sample is stored for each set of unique attributes per pixel. Similarly, pixel p+1 had all four of its samples with the same or substantially the same attributes allowing only one sample to be stored to represent all four of the samples. Pixel p+2, however, had each of its samples with different attribute values, and therefore is required to store all four of its samples. The compressed samples 211, 212, and 213, respectively, of pixels p, p+1, and p+2, can be stored in a memory in arrangements so as to optimize the memory footprint and access. By representing more than one sample using a stored sample when multiple samples have the same or substantially the same attribute values, the compressed AA storage 202 can result in a substantially smaller memory footprint than the conventional AA storage where all samples are stored.

The number of samples in 4×AA for a pixel that results in different attribute values can be dependent on the number of objects that touch the pixel. If, for example, a pixel is entirely covered by an object, then all the samples for that pixel will have the same attributes. If a pixel is touched by one object, then one or more samples will have one set of attributes, and the other samples will have another set of attributes resulting in two unique sets of attributes. If three objects touch the pixel, then it is possible that the pixel can have up to four unique sets of attributes in its samples.

Metadata table 204 includes an entries for respective pixels stored in compressed AA sample storage 202. In 4×AA compression, a pixel's entry in metadata table 204 includes 4 sub entries, where each sub entry represents a corresponding one of the samples generated for that pixel. The value of a sub entry represents a pointer to a sample stored in the compressed AA sample storage 204 according to the compression scheme in an embodiment of the present invention. For example, in the entry 221 for pixel p, sub entry 0 points to pixel p sample 00 in compressed AA sample storage 204 while sub entries 01-03 all point to pixel p sample 01. In entry 222 for pixel p+1, all sub entries point to pixel p sample 00 in compressed AA sample storage 204. In entry 223 for pixel p+2, subentries 0, 1, 2, and 3, point respectively to pixel p+2 samples 00, 01, 02, and 03. Although illustrated as a table, metadata table 204 can be implemented as any data structure that has the capability to function as described above.

### Method for Reading Compressed AA Samples

FIG. 3 is a flowchart illustrating a method 300 to render a pixel from compressed AA samples, according to an embodiment of the present invention. Method 300 is primarily described herein using multisampled samples. It should be noted that other forms of AA such as, for example, supersampling are possible, and that method 300 can be applied to those methods of AA. Furthermore, for ease of description, method 300 is described herein using as an example the multisampled samples of a pixel from the multisampled image.

In operation 302, a multisampled image is rendered. For example, subsequent to processing in the graphics pipeline, a rendering logic can take as input the output from a pixel shader stage and produce the rendered image. Several forms of AA can be applied. According to an embodiment, 4×AA multisampling is applied to the rendered surface. Accordingly, 4 samples are generated for each pixel of the surface.

In operation 304, the multisampled image is compressed before it is stored in a memory. According to an embodiment, multisampled image is compressed by not storing any samples with duplicate attribute values as described, for example, in relation to FIG. 2 above. According to an embodiment, for each pixel, samples are stored in a memory while ensuring that only samples with non-duplicate attribute values are actually stored. A metadata entry is maintained for each pixel where they metadata entry has a sub entry for each generated sample for that pixel. The value of respective sub entries are set, for example, in operation 304 to correspond to the actual stored sample in the compressed AA samples that is representative of the generated sample.

Operations 302-304 can be repeated to compress an entire rendered image and store the rendered image in a memory. The rendered image in compressed form can be stored in system memory or a graphics memory. The compression according to an embodiment of the present invention facilitates storing of rendered surfaces in faster graphics memory by reducing the size of the required memory footprint. When the entire image has been rendered in the example 4×AA multisampling, a metadata such as metadata table 204 including entries for each respective pixel of the rendered image, and a sample storage in a memory, such as compressed AA sample storage 202 are populated.

In operation 306, a shader program or other program requests a pixel from the rendered surface. For example, a texture mapping program can request a pixel or one or more samples of a pixel. According to an embodiment, the requesting program can generate a request specifying a pixel identifier p and a sample identifier, for example, an integer 0-3, requesting one of the four samples generated for pixel p in 4×AA. According to an embodiment, texture mapper 122 can generate the above request by itself or based on a request by another program or application programming interface (API).

In operation 308, a metadata of the compressed AA samples stored in memory is accessed. For example, an entry in metadata table 132 corresponding to compressed AA samples 134 can be accessed. For the requested pixel, the metadata includes a pointer to a stored multisampled sample corresponding to each generated sample. FIG. 2 above shows an example compressed AA multisampled sample storage 202 and metadata table 204. The metadata can be accessed by retrieving the metadata table from a memory, such as, a graphics memory local to a GPU or a system memory. The metadata table is of relatively small size compared to the compressed sample. For example, in 4×AA the entry for each pixel can comprise 4 entries of two bits each sufficient to represent samples 0-3. According to an embodiment, the logic to access the metadata can be included in a logic module such as compressed AA sample reader 124.

In operation 310 the available samples for the requested pixel is determined. According to an embodiment, the subset of samples that are actually stored in memory for the requested pixel is determined based on the metadata. For example, as illustrated in FIG. 2, in 4×AA multisampling, the values of the four sub entries of the pixel's metadata entry can be considered to determine the available subset of samples. The number of different values in the sub entries of the pixel's metadata entry defines how many samples are actually stored in the compressed AA sample storage for that pixel. The values of the sub entries define the actual samples in the subset. For example, if a request is received for pixel p+1, the corresponding metadata entry 222 indicates that only one sample is stored in compressed AA samples storage 202 for pixel p+1. All four sub entries of entry 222 are set to ‘00’ indicating that the stored entry 00 has attributes that are the same or substantially similar to the attributes of all generated multisampled samples.

In operation 312, the samples to be retrieved are determined. For example, following the example set forth in the previous paragraph, if sample 2 of pixel p+1 is requested, it is determined what sample or samples are to be returned. Based on entry 222, for example, it can be determined that sample ‘00’ is stored in compressed multisampled AA samples to represent all samples 0-3 for pixel p+1. Thus, although the request is for sample 2 of pixel p+1, it is determined that sample 0 can be returned.

In operation 314, the one or more samples of the pixel determined to be retrieved are retrieved from a memory. According to an embodiment, a memory request is initiated to retrieve the sample specified in the corresponding sub entry of the pixel's metadata entry. If the sample was previously returned, for example, in response to the request for another sample of the same pixel, then that sample can be returned from a local cache or memory without having to access the sample in compressed AA sample storage. Such returning of previously returned samples from a local cache or memory can help reduce the utilization of memory bandwidth.

In another embodiment, an application, such as a texture mapping application or other application invoking the compressed AA sample reader through an API, may itself determine the samples to be retrieved by accessing the corresponding entry in metadata. For example, the texture mapping application 122 can receive the metadata entry for a requested pixel from the compressed AA sample reader 124. After receiving or obtaining access to the relevant metadata entry, the application itself can determine what samples for the pixel have to be retrieved from memory and what samples can be substituted for by another sample. In this manner, the application itself can determine the samples to be retrieved, leading to further efficiencies over the conventional method of retrieving all samples generated for a pixel regardless of the number of samples that have different attribute values.

In operation 316, the received sample is returned to the requesting program or thread.

In step 318, it is determined whether more pixels remain to be processed using operations 306-316. If yes, steps 306-318 are repeated. If no, process 300 completes having, for example, rendering and/or texture mapping the image from compressed AA samples.

Instructions executed by the logic to perform aspects of the present invention can be coded in a variety of programming languages, such as C and C++, Assembly, and/or a hardware description language (HDL) and compiled into object code that can be executed by the logic or other device.

The embodiments described above can be described in a hardware description language such as Verilog, RTL, netlists, etc. and that these descriptions can be used to ultimately configure a manufacturing process through the generation of maskworks/photomasks to generate one or more hardware devices embodying aspects of the invention as described herein.

Aspects of the present invention can be stored, in whole or in part, on a computer readable media. The instructions stored on the computer readable media can adapt a processor to perform embodiments of the invention, in whole or in part.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method to render a pixel from a compressed anti-aliased image, comprising:
accessing metadata for the pixel, wherein the metadata includes entries for respective samples generated by multisampling the pixel; and
retrieving a subset of said samples based upon the metadata, wherein the subset is stored in the compressed anti-aliased image stored in a memory.

2. The method of claim 1, wherein a plurality of said entries identify a first sample in the subset of said samples.

3. The method of claim 2, wherein attributes of the first sample are substantially similar to attributes of one or more others of said samples.

4. The method of claim 1, further comprising:
receiving a request to read a first sample of the pixel; and
returning one or more said samples of the subset in response to the request.

5. The method of claim 4, further comprising:
mapping the first sample to one of said samples from the subset.

6. The method of claim 5, wherein a sample position of the first sample and a sample position of the one of said samples from the subset are different.

7. The method of claim 4, wherein the request is generated from a shader program.

8. The method of claim 4, further comprising:
texture mapping the pixel using one or more said samples of the subset.

9. The method of claim 1, further comprising:
receiving a request to read the pixel; and
returning the subset of said samples in response to the request.

10. The method of claim 1, wherein the accessing comprises:
retrieving the metadata from a metadata table, wherein the metadata table represents all pixels in the compressed anti-aliased image.

11. The method of claim 1, wherein the retrieving comprises:
generating a first number of memory requests to access the subset in the memory, wherein the first number is not greater than the number of samples in the subset.

12. A system to render a pixel from a compressed anti-aliased image, comprising:
a processor;
at least one memory configured to store:
the compressed anti-aliased image; and
a metadata table comprising a metadata for the pixel; and
a compressed anti-aliased image reader configured to:
access the metadata, wherein the metadata includes entries for respective samples generated by multisampling the pixel; and
retrieve a subset of said samples based upon the metadata, wherein the subset is stored in the compressed anti-aliased image.

13. The system of claim 12, wherein the compressed anti-aliased image reader is further configured to:
receive a request to read a first sample of the pixel;
mapping the first sample to one of said samples from the subset; and
return one or more said samples of the subset in response to the request.

14. The system of claim 13, further comprising:
a texture mapper configured to texture map the pixel using one or more said samples of the subset.

15. The system of claim 13, wherein the compressed anti-aliased image reader is further configured to:
receive the request from a shader program.

16. The system of claim 12, wherein the compressed anti-aliased image reader is further configured to:
generate a first number of memory requests to access the subset in the memory, wherein the first number is not greater than the number of samples in the subset.

17. A computer readable media storing instructions wherein said instructions when executed are adapted to render a pixel from a compressed anti-aliased image using at least one processor with a method comprising:
accessing metadata for the pixel, wherein the metadata includes entries for respective samples generated by multisampling the pixel; and
retrieving a subset of said samples based upon the metadata, wherein the subset is stored in the compressed anti-aliased image stored in a memory.

18. The computer readable media of claim 17, the method further comprising:
receiving a request to read a first sample of the pixel; and
returning one or more said samples of the subset in response to the request.

19. The computer readable media of claim 18, the method further comprising:
mapping the first sample to one of said samples from the subset.

20. The computer readable media of claim 17, wherein the accessing comprises:
retrieving the metadata from a metadata table, wherein the metadata table represents all pixels in the compressed anti-aliased image.
